(19) United States
(12) Patent Application Publication
(10) Pub. No.: US 2009/0179116 A1
(43) Pub. Date: Jul. 16, 2009

(54) CABLE MANAGEMENT SIDE BRACKET

(76) Inventors: Patrick St-Louis, Boisbriand (CA); Yannick Demers, St-Jean-Sur-Richelieu (CA)

Correspondence Address: GOUDREAU GAGE DUBUC, 2000 MCGILL COLLEGE, SUITE 2200, MONTREAL, QC, H3A 3H3, CA

(21) Appl. No.: 12/352,360

(22) Filed: Jan. 12, 2009

Related U.S. Application Data
(60) Provisional application No. 61/020,512, filed on Jan. 11, 2008.

(51) Int. Cl. F16L 3/22

(52) U.S. Cl. 248/68.1

(57) ABSTRACT

A side bracket mounted to a patch panel frame for supporting cables connected to the frame. The bracket is mounted to a side of the frame adjacent one of a pair of spaced vertical rails the frame is mounted between. The bracket comprises a first and a second bracket member detachably coupled to one another using a snap-fit mechanism and extends away from a rear surface of the frame along a plane substantially perpendicular to the plane spanned by the frame. Cables connected to the frame are then routed away from the rear surface towards the side bracket, thus freeing space at the rear of the patch panel.

### CROSS REFERENCE TO RELATED APPLICATIONS

This application claims priority, under 35 U.S.C. § 119(e), of U.S. provisional application Ser. No. 61/020,512, filed on Jan. 11, 2008 and which is incorporated herein in its entirety by reference.

### FIELD OF THE INVENTION

The present invention relates to a cable management side bracket. In particular, the bracket is mounted to the side of a patch panel frame in order to support cables connected thereto.

### BACKGROUND OF THE INVENTION

As known in the art, local area networks and telecommunications connections often use patch panels to enable connection between telecommunications equipment. In order to keep the various cables connected to the patch panels organized and protected from damage, there is an increasing need for cable management. Cable management bars are typically used to provide a support structure where a plurality of cables may be supported, thus preventing excessive bending of the cable and resulting loss of performance. However, a major drawback with cable management bars is that they can be difficult to mount and once affixed to the patch panels impedes the installer's access to the back of the patch panel. In addition, these bars typically need to be uninstalled in order for an operator to reach the cable connectors as the cables are in the way.

What is therefore needed, and an object of the present invention, is improved patch panel cable management, which will efficiently support cables while easing access to cable connectors.

### SUMMARY OF THE INVENTION

In order to address the above and other drawbacks, there is provided in accordance with the present invention a cable management side bracket adapted to be mounted to a patch panel for supporting a plurality of cables connected to the patch panel, the patch panel comprising a planar frame spanning a pair of spaced vertical rails and defining a first plane. The frame has mounted thereto a plurality of connectors each adapted to connect one of the plurality of cables to the frame. The bracket comprises a first bracket member mounted to a rear surface of the frame at a first side thereof adjacent a corresponding one of the pair of rails and a second elongate bracket member detachably coupled at a first end thereof to the first bracket member. The second bracket member extends away from the rear surface along a second plane substantially perpendicular to the first plane for supporting the plurality of cables.

In accordance with the present invention, there is also provided a method for mounting a cable management side bracket to a patch panel for supporting a plurality of cables connected to the patch panel, the patch panel comprising a planar frame spanning a pair of spaced vertical rails and defining a first plane. The frame has mounted thereto a plurality of connectors each adapted to connect one of the plurality of cables to the frame. The method comprises providing a first bracket member, providing a second elongate bracket member, mounting the first bracket member to a rear surface of the frame at a first side thereof adjacent a corresponding one of the pair of rails and detachably coupling the second bracket member to the first bracket member such that the second bracket member extends away from the rear surface along a second plane substantially perpendicular to the first plane for supporting the plurality of cables.

### BRIEF DESCRIPTION OF THE DRAWINGS

In the appended drawings:

FIG. 1 is a right front perspective view of a patch panel with side brackets mounted on a telecommunications rack in accordance with an illustrative embodiment of the present invention;

FIG. 2A is a top plan view of a patch panel with side brackets mounted on a telecommunications rack in accordance with an illustrative embodiment of the present invention;

FIG. 2B is a right side plan view of a patch panel with side brackets in accordance with an illustrative embodiment of the present invention;

FIG. 3A is a rear perspective view of a patch panel with side brackets in accordance with an illustrative embodiment of the present invention;

FIG. 3B is a perspective view of a side bracket in accordance with an illustrative embodiment of the present invention;

FIG. 3C is a front view of a side bracket member in accordance with an illustrative embodiment of the present invention;

FIG. 4A is a perspective view of a side bracket in accordance with an alternative illustrative embodiment of the present invention;

FIG. 4B shows a detailed view of a side bracket with spring tab in accordance with an alternative illustrative embodiment of the present invention;

FIG. 5A is a right front perspective view of a patch panel with side brackets in accordance with an alternative illustrative embodiment of the present invention; and

FIG. 5B is a right front perspective view of a patch panel with side brackets in accordance with another alternative illustrative embodiment of the present invention.

### DESCRIPTION OF ILLUSTRATIVE EMBODIMENTS

The present invention is illustrated in further details by the following non-limiting examples.

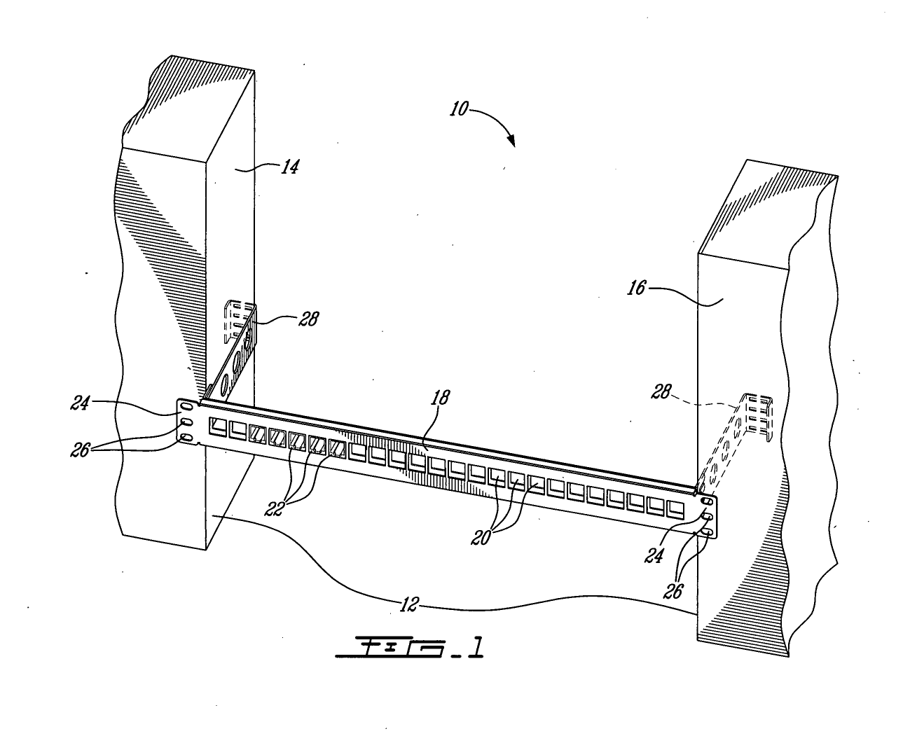

Referring now to FIG. 1, and in accordance with an illustrative embodiment of the present invention, a patch panel, generally referred to using the reference numeral 10, will now be described. The patch panel 10 is illustratively mounted to a standard network rack 12 comprising two spaced vertical side rails 14 and 16. The patch panel 10 comprises a planar frame 18 having a plurality of apertures 20 for mounting connector modules as in 22 therein. It will be apparent to a person skilled in the art that the apertures as in 20 may be adapted to receive other types of connection modules as in 22, such as Insulation Displacement Connector (IDC) modules (e.g. 10GC IDC modules) that allow wall-mounted configuration of large cross-connect systems and interconnect rack-mounted systems. Mounting plates 24 are formed integrally with the frame 18 at each extremity thereof and comprise mounting apertures 26, which allow the frame 18 to be mounted to the rails 14 and 16 through the use of fasteners such as nuts, bolts, and the like (not shown). A side-mount bracket 28 is also mounted on each extremity of the frame 18 adjacent to each mounting plate 24. Illustratively, the brackets 28 project away from the rear face of the frame 18.

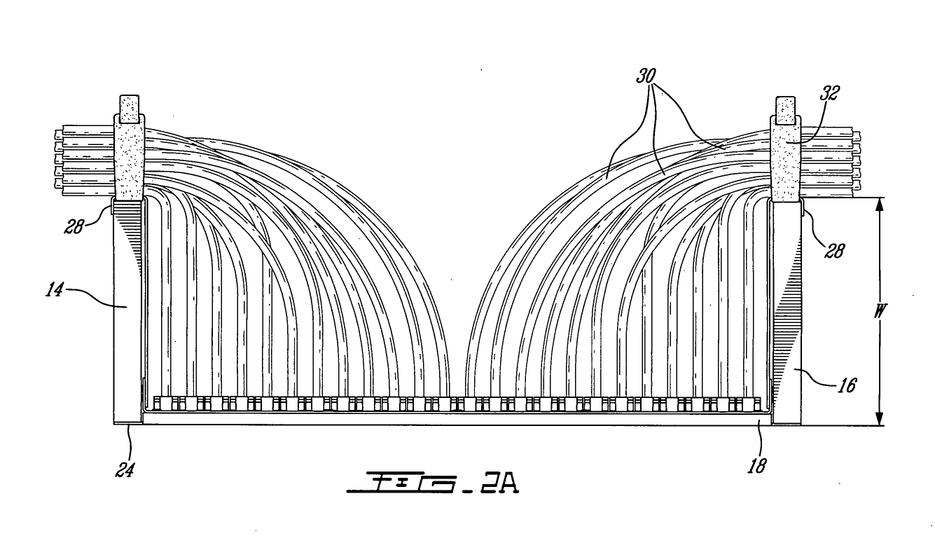

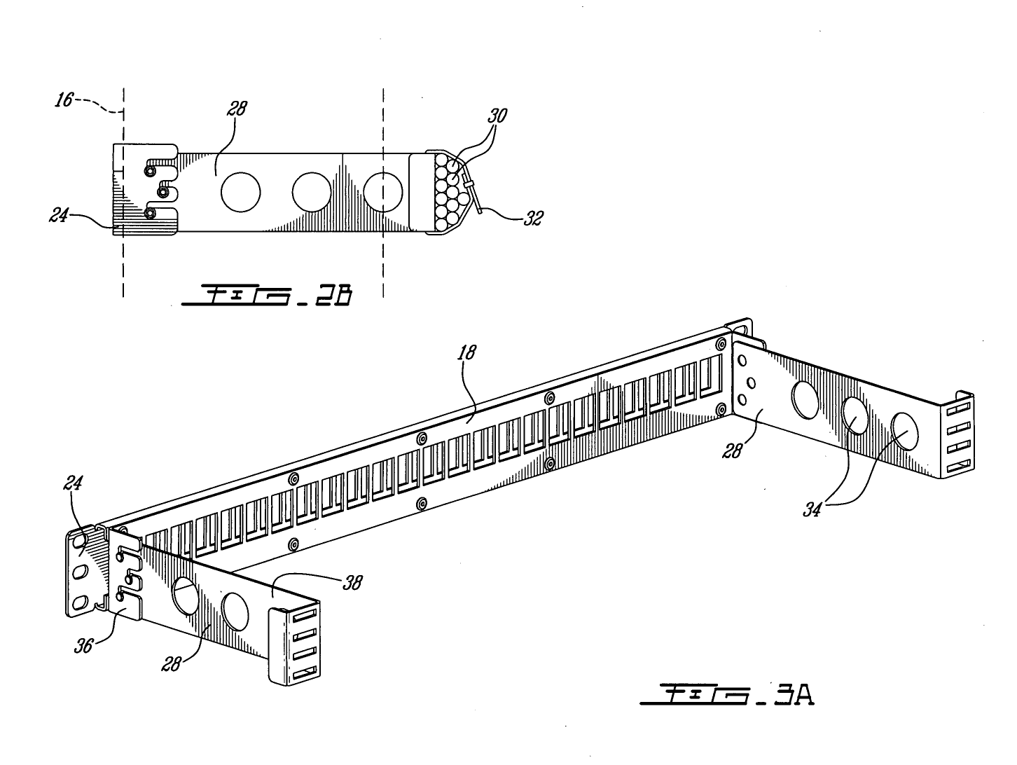

Referring now to FIG. 2A and FIG. 2B in addition to FIG. 1, the bracket 28 is used to support cables as in 30, which are connected to the frame 18 of the patch panel 10 via the connectors 22. The bracket 28 can illustratively be made of steel, plastic, or some other suitable rigid material (depending on the application) and is illustratively designed to support a maximum of 48 cables as in 30. For this purpose, the bracket 28 allows for a fastener 32, such as a cable tie using Velcro™ strap or the like, to be attached thereto to hold the cables 30, as will be described herein below. Each bracket 28 is therefore sized to have a length slightly greater than the width W of a side rail 14 or 16 in order to provide sufficient space to attach the fastener 32 to the bracket 28. Illustratively, in order to ease access to the rear of the connectors 22, the cables 30 are divided and routed towards each side of the patch panel 10 (i.e. towards each side rail 14 or 16) to be supported by a side bracket as in 28. Mounting a pair of brackets as in 28 to the frame 18 allows to clear a great amount of space at the rear of the frame 18 by supporting the cables as in 30 in both brackets 28, thus providing operators with sufficient room at the back of the frame 18 to easily access the rear of all connectors 22. Depending on the application, the cables 30 may also all be routed to a single side of the frame 18 (i.e. to one bracket 28 only) if desired. Provision of the bracket 28 provides an installer with room to operate without having to untie any of the cables 30 during both initial installation and/or during any rework. Moreover, the bracket 28 alleviates the need for horizontal cable management support bars and as a result no components clutter the rear of the patch panel 10, thereby improving accessibility to the back of the patch panel 10.

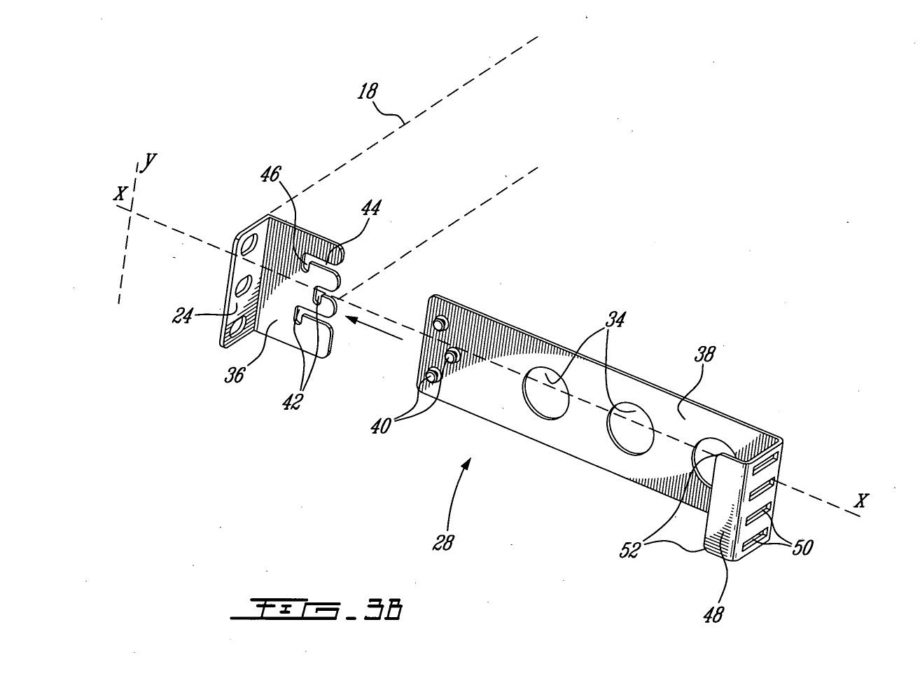

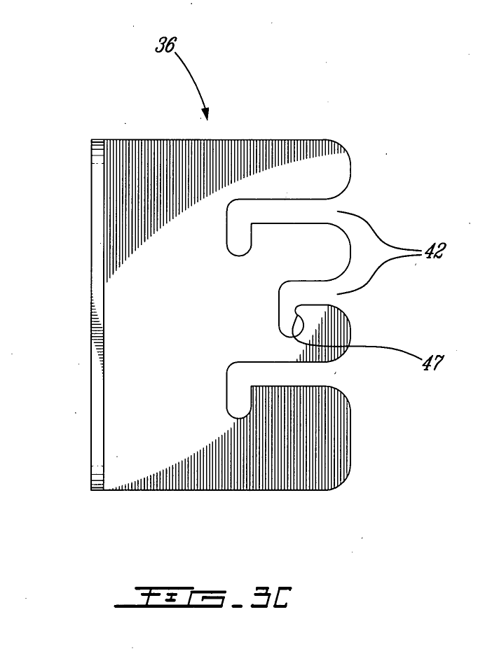

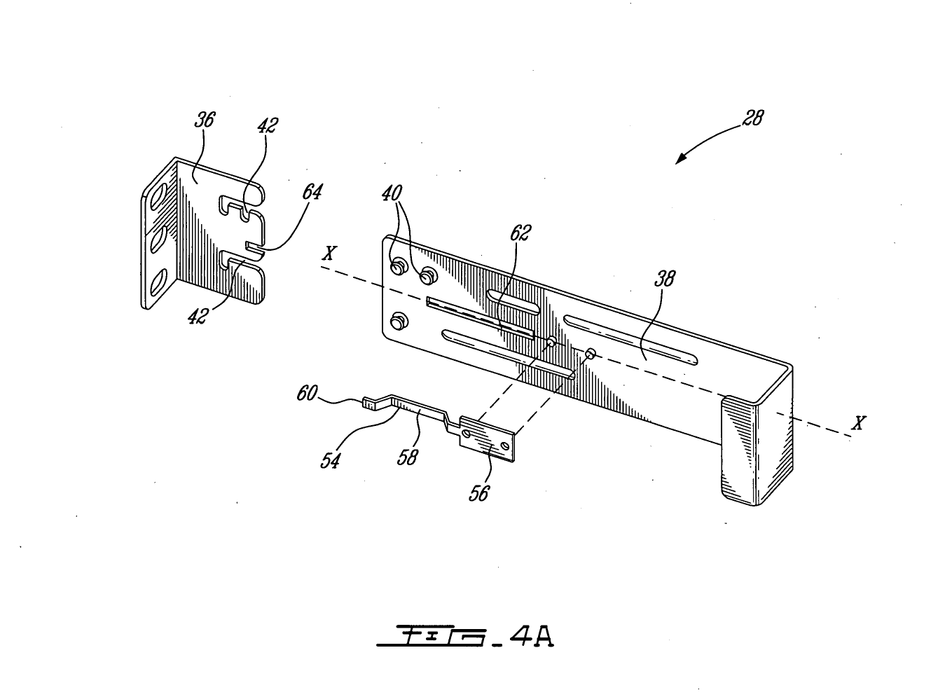

Referring now to FIG. 3A and FIG. 3B, the bracket 28 illustratively comprises openings 34 that advantageously provide a point where the operator's fingers can grip the bracket 28 and be inserted into the openings 34 during installation or removal of the bracket 28. As will be apparent to a person skilled in the art, enhanced gripping provision is especially desired when a plurality of brackets as in 28 are stacked (as they typically are) one on top of the other over the length of the vertical rails (references 14 and 16 in FIG. 1). It will also be apparent that although three (3) openings 34 have been represented for the sake of illustration, the number of openings 34 can vary as desired. Moreover, it will be apparent that the openings as in 34 may have a different shape as the one illustrated in FIG. 3A and FIG. 3B, as well as be replaced by a narrowing along the width of the bracket 28 (not shown), which also provides enhanced gripping.

Still referring to FIG. 3A and FIG. 3B, the bracket 28 illustratively comprises a first bracket member 36 and a second bracket member 38, which are detachably coupled along a plane substantially perpendicular to the plane of the frame 18. Illustratively, the second member 38 has mounted at a proximal end thereof a plurality (two or more) of pins as in 40, which are adapted to mate with notches as in 42 formed in the second member 36, thus attaching the members 36 and 38 together to form the bracket 28. The pins as in 40, which are commercially available components, are illustratively mounted to the member 38 in a pattern (e.g. offset) matched by the notches as in 42. The disposal of the pattern of pins as in 40 gives more strength to the bracket 28 by preventing any unsteady movement, e.g. from right to left, once the bracket 28 has been assembled and installed on the frame 18. Also, the pattern ensures that the weight supported by the bracket 28 is equally divided at each pin 40, thus further maximizing the strength of the assembly.

Still referring to FIG. 3A and FIG. 3B, the notches as in 42 are illustratively L-shaped to allow the pins as in 40 to be secured therein. For this purpose, the notches as in 42 comprise an elongate portion 44, which extends along the longitudinal axis X of the bracket member 38, and an end portion 46, which extends along the axis Y substantially orthogonal to the axis X and allows each pin as in 40 to be secured in its respective notch as in 42. In order to attach the bracket member 38 to the bracket member 36, thus mounting the bracket 28 to the frame 18, the pins as in 40 are illustratively introduced into the elongate portion 44 of the notches as in 42 by sliding the member 38 along the axis X in a first movement. In a second movement, the member 38 is pushed downwards (in the Y direction) to abut the pins as in 40 against the end portion 46 of the notches as in 42. Accidental removal of the member 38 is thus prevented as the pins 40 are securely held in place into the notches as in 42. Referring to FIG. 3C, one or more of the notches as in 42 are illustratively equipped with a raised abutment 47 which acts as a locking mechanism that will further retain the pin (reference 40 in FIG. 3B) within notch 42.

Referring now to FIG. 2, FIG. 3A and FIG. 3B, it will now be apparent to a person skilled in the art that the member 36 may be formed integrally as part of the frame 18 (e.g. integral to the mounting plate 24 as illustrated in FIG. 3B) or may be mounted thereon via bolts and the like (not shown). Also, each bracket 28 can be installed prior to mounting the cables 30 to their respective connectors 22 or alternatively installed after the cables 30 are in place. The snap-fit design of the bracket 28 of the present invention further allows for it to be advantageously uninstalled at any time.

Still referring to FIG. 3A and FIG. 3B in addition to FIG. 2, a cable support plate 48, which is illustratively L-shaped, is formed at the distal end of the bracket member 38 along a plane substantially parallel to the plane of the frame 18. Slots as in 50 are illustratively manufactured in the support plate 48 to allow for the cables 30 to be supported as mentioned herein above using the fastener (such as Velcro™ strap or cable tie or the like) 32, which is attached to the support plate 48 via the slots as in 50. In addition, the corners as in 52 of the support plate 48 are illustratively rounded in order to avoid damaging the protective jacket of the cables as in 30 routed to and supported by the bracket 28. In particular, the rounded corners as in 52 prevent the outside jacket of each cable 30 from being punctured, as would potentially be the case with a bracket having sharp edges. As will be apparent to a person skilled in the art, the cable support plate 48 can also be of any suitable shape other than L-shaped.

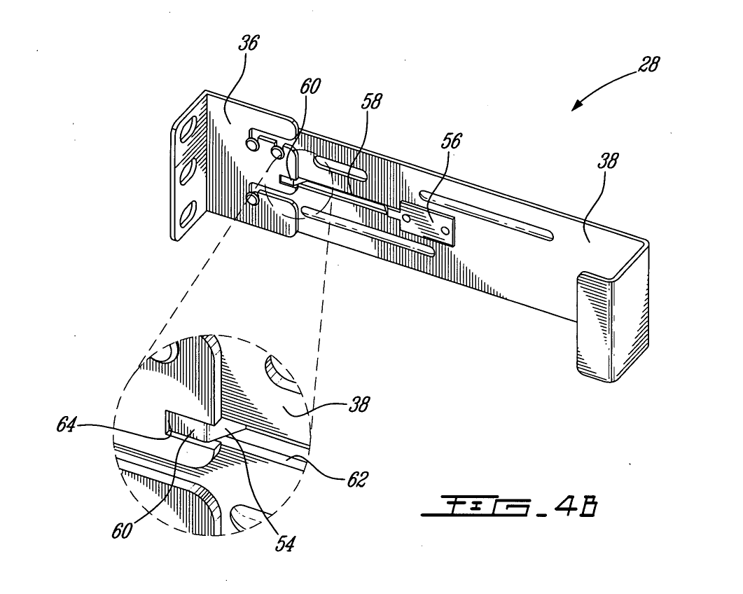

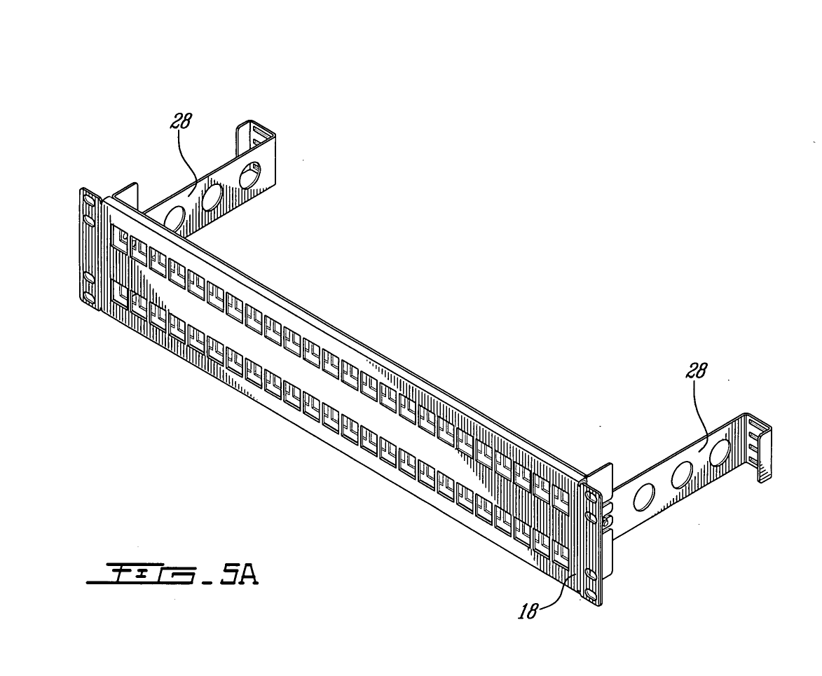

Referring now to FIG. 4A and FIG. 4B, in an alternative embodiment of the present invention, a different pattern of pins as in 40 may be used to give more strength to the bracket 28, as mentioned herein above. Also, in addition to pins as in 40, the first bracket member 36 may be further coupled to the second bracket member 38 with a spring tab 54 attached to the second bracket member 38. Illustratively, the spring tab 54 is integrally formed of a substantially flat tab 56, an elongate member 58 positioned along an axis offset from the longitudinal axis of the tab 56, and a flange member 60 positioned substantially in alignment with the tab 56. The spring tab 54 is illustratively mounted to the bracket member 38 by fastening the tab 56 to the bracket member 38 using spot-welding or the like with the elongate member 58 being received in an elongate slot 62 machined into the bracket member 38 along the longitudinal axis X of the bracket member 38. When so mounted, the offset elongate member 58 is retained within the slot 62 and the flange member 60 extends outwardly away from the slot 62 (see FIG. 4B). A notch 64 is illustratively machined into the bracket member 36 (in addition to the notches 42 used to receive the pins 40) to receive the flange member 60, thus further locking the first and second bracket members 36 and 38 into place. As will be apparent to a person skilled in the art, other attachment means not described herein may be used to couple the first bracket member 36 to the second bracket member 38.

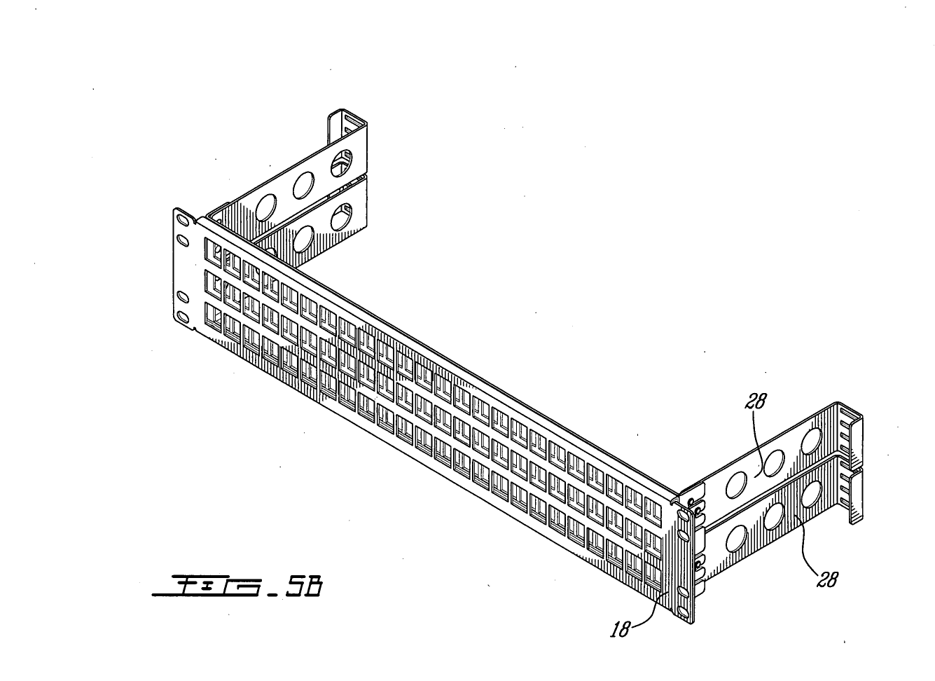

Referring now to FIG. 5A and FIG. 5B in addition to FIG. 1, each bracket 28 is illustratively designed to fit a frame size of one (1) rack unit (1U). Still, it may be possible to cover larger frame sizes (e.g. 2U and more) using a single bracket 28 (as shown in FIG. 5A) or by stacking a plurality of brackets 28 (illustratively two (2) as shown in FIG. 5B) one on top of the other to cover the desired frame height. As a result, the bracket 28 can be advantageously adapted for use with a variety of already existing telecommunications equipment.

Although the present invention has been described hereinabove by way of specific embodiments thereof, it can be modified, without departing from the spirit and nature of the subject invention as defined in the appended claims.

We claim:

1. A cable management side bracket adapted to be mounted to a patch panel for supporting a plurality of cables connected to the patch panel, the patch panel comprising a planar frame spanning a pair of spaced vertical rails and defining a first plane, the frame having mounted thereto a plurality of connectors each adapted to connect one of said plurality of cables to the frame, the bracket comprising:
a first bracket member mounted to a rear surface of the frame at a first side thereof adjacent a corresponding one of the pair of rails; and
a second elongate bracket member detachably coupled at a first end thereof to said first bracket member, said second bracket member extending away from said rear surface along a second plane substantially perpendicular to the first plane for supporting the plurality of cables.

2. The bracket of claim 1, further comprising a plurality of pins mounted at said first end of said second bracket member and a plurality of notches formed in said first bracket member, each one of said plurality of notches adapted to receive therein a corresponding one of said plurality of pins for detachably coupling said second bracket member to said first bracket member.

3. The bracket of claim 2, wherein said plurality of pins are mounted at said first end in a pattern matched by a positioning of said plurality of notches in said first bracket member for added structural rigidity.

4. The bracket of claim 2, wherein each one of said plurality of notches is L-shaped and comprises an end portion adapted to retain said corresponding pin therein for locking said second bracket member in place relative to said first bracket member.

5. The bracket of claim 1, further comprising a cable support plate formed at a second end of said second bracket member opposite said first end.

6. The bracket of claim 1, further comprising a spring tab for detachably coupling said second bracket member to said first bracket member.

7. The bracket of claim 5, further comprising a fastener attached at said second end for holding the plurality of cables in place relative to the frame.

8. The bracket of claim 7, wherein a length of said coupled first and second bracket members is greater than a width of said corresponding one of the pair of rails for providing sufficient space to attach said fastener at said second end.

9. The bracket of claim 1, further comprising a second one of the bracket mounted to a rear surface of the frame at a second side thereof opposite said first side and adjacent the second one of the pair of rails.

10. The bracket of claim 1, further comprising gripping provisions formed in said second bracket member.

11. The bracket of claim 1, wherein said first and said second bracket members are sized to fit a height of the frame.

12. A method for mounting a cable management side bracket to a patch panel for supporting a plurality of cables connected to the patch panel, the patch panel comprising a planar frame spanning a pair of spaced vertical rails and defining a first plane, the frame having mounted thereto a plurality of connectors each adapted to connect one of said plurality of cables to the frame, the method comprising:
providing a first bracket member;
providing a second elongate bracket member;
mounting said first bracket member to a rear surface of the frame at a first side thereof adjacent a corresponding one of the pair of rails; and
detachably coupling said second bracket member to said first bracket member such that said second bracket member extends away from said rear surface along a second plane substantially perpendicular to the first plane for supporting the plurality of cables.

13. The method of claim 12, further comprising providing a plurality of pins at said first end of said second bracket member and a plurality of notches on said first bracket member, said detachably coupling said second bracket member to said first bracket member comprising inserting each one of said plurality of pins into a corresponding one of said plurality of notches.
